(19) United States
(12) Patent Application Publication
(10) Pub. No.: US 2007/0180388 A1
(43) Pub. Date: Aug. 2, 2007

(54) Method of Peer Review of a Web-Based Encyclopedia

(76) Inventor: Eugene M. Izhikevich, San Diego, CA (US)

Correspondence Address: Eugene M. Izhikevich, 10844 Corte de Marin, San Diego, CA, 92130, US

(21) Appl. No.: 11/619,194

(22) Filed: Jan. 3, 2007

Related U.S. Application Data
(60) Provisional application No. 60/756,012, filed on Jan. 4, 2006.

(51) Int. Cl. G06F 3/00; G06F 17/30; G06F 7/00; G06F 17/00; G06F 15/16

(52) U.S. Cl. 715/751; 715/511; 707/203; 707/100; 715/530; 709/204

(57) ABSTRACT

The invention concerns a method of creation, maintenance, and peer-review of web-based collectively written encyclopedia. The invention combines the mechanism of Wiki-style collaborative environment, which allows users to modify articles, with the principles of peer-reviewed encyclopedias, in which articles are approved (i.e., endorsed) by experts. In the preferred embodiment, each article has a curator or curators who are responsible for the article content. Each article can be modified by users, but the modification is hidden from the general public until it is evaluated and approved by the curators. The encyclopedia stores the history of all revisions and evaluations. If the curators fail to evaluate the modification within a certain predefined period of time, the curatorship of the article is offered to the person who made useful modifications to the article (according to the history of evaluations). This method ensures that each article has a curator who maintains its content in a timely manner.

### CROSS-REFERENCE TO RELATED APPLICATIONS

This is a non-provisional application filed under 37 C.F.R. 1.53(b), claiming priority under 35 U.S.C. 119(e) to Provisional Application Ser. No. 60/756,012, filed on Jan. 04, 2006.

### FIELD OF THE INVENTION

The present invention concerns the method of development, maintenance, and peer-review of web-based encyclopedias whose content can be collectively written and edited by users.

### BACKGROUND OF THE INVENTION

Peer review process is an innate part of scholarly activity. Typically, an article submitted to a journal is assigned a number of reviewers (preferably experts in the field of the paper) who read it and write their critical comments. Then the author is given a chance to address the comments and revise the article. When all comments are addressed to the reviewers satisfaction, the article is accepted for publication. Otherwise, it is rejected. This process is designed to improve the quality and prevent incompetent publications. The drawback is that the article is published in the final form and it cannot be corrected or modified to incorporate new data or ideas.

With the advent of web-based collectively written encyclopedias, such as Wikipedia (www.wikipedia.org), submission process becomes easy. Anybody can write an article and submit it as an entry (also known as a page) to the encyclopedia. Anybody can modify an existing article to include new data and ideas, making such encyclopedias up-to-date. As a result of bypassing the stringent review process, such web-based collectively written encyclopedias could have incompetent pages. (Two attempts to create web-based encyclopedias, known as NuPedia and GNUPedia, using the standard submission and peer-review process failed due to the lack of participants. Other attempts, such as Stanford Encyclopedia of Philosophy and The Encyclopedia of Earth, are successful).

Most such web-based collectively written encyclopedias, including Wikipedia, rely on the principles of collaborative environment called Wiki. The principle was developed in 1994 by Ward Cunningham and called Wiki Wiki after the shuttle bus line in Honolulu International Airport (Wiki means quick in Hawaiian). The Wiki principle allows quick modification/revision of encyclopedia pages by creating a new copy of the page but saving the old one, so that there is a history of all revisions. The wiki principle is most suitable for the cases when many people edit the same page at the same time; the history of each page provides the information on what was changed, who made the change, when, etc. Since each version of the page can be viewed, unwanted or erroneous changes can quickly be reverted, multiple versions can me merged, and other useful manipulations of the information can be easily done. Presently, there are over 1,000 wiki sites, with Wikipedia being the most known one.

The greatest feature of Wikipedia (and other types of wiki-style collaborative environment, such as PlanetMath) is its openness: anybody with the access to the Internet can edit and modify pages (i.e., articles) in Wikipedia and everybodys modifications are treated equal. Typically, an article undergoes a quick growth with many modifications done by hundreds if not thousands of people and then it slowly asymptotes at the level in which few new modifications are needed. Some call such articles mature; they represent the consensus of opinions, and, ideally, do not contain any erroneous information.

The open spirit of Wikipedia allows experts in one field to modify articles in other fields. For example, a neuroscientist can modify articles in neuroscience, as well as, in mathematics. Looking at this from the other side, an article in mathematics can be modified by a mathematician, by a neuroscientist, or by anybody else. Taken into account that many of Wikipedia participants are high-school or undergraduate students, it is amazing how many good articles Wikipedia has. However, there are many articles containing biased or erroneous information, spam, and obscenity (vandalism). Wikipedia has to rely on the army of volunteers (called Wikipedians) to sift through all modifications and reverting spam and vandalism. Unfortunately, non-expert volunteers cannot distinguish which of the normal-looking modifications are legitimate improvements to an article and which are hidden vandalism or practical jokes (e.g., changing a plus sign to a minus sign in an equation in a math article).

Wikipedia remains one of the most comprehensive free sources of information for the general public. However, publications in Wikipedia bypass the stringent peer-review process, and hence Wikipedia is not widely accepted in the academic circles. Few articles in Wikipedia are sited in scientific publications. Scientists prefer to use peer-reviewed journals and conventional (printed) encyclopedias written by experts, such as Encyclopedia Britannica. In these journals and encyclopedias, articles are peer-reviewed and endorsed by the army of paid and unpaid experts and checked by the editorial staff. The drawback of journal articles is that there is no mechanism to modify the articles, e.g., to correct an error, except to publish an errata. Similarly, there is no simple mechanism to modify articles or to add new articles to conventional (printed) encyclopedias other than to print new editions every few years or so.

### SUMMARY OF THE INVENTION

The invention concerns a method of creation, maintenance, and peer-review of web-based collectively written encyclopedia. The invention combines the mechanism of Wiki-style collaborative environment, which allows users to modify articles, with the principles of peer-reviewed encyclopedias, in which articles are approved (i.e., endorsed) by experts. In the preferred embodiment, articles have curators who are responsible for their content. Each article can be modified by users, but the new version is hidden from the general public until it is evaluated and approved by the curators. The encyclopedia stores the history of all such revisions and evaluations. If the curators of the article fail to evaluate the new version within a certain predefined period of time, the curatorship of the article is offered to the person who made most useful modifications to the article (according to the history of evaluations). This method ensures that each article has a curator who maintains its content in a timely manner.

### DETAILED DESCRIPTION OF THE PREFERRED EMBODIMENT

Definitions:

ELECTRONIC ENCYCLOPEIA is a collection of entries stored in a computer memory. Often, it is located on a web server and can be viewed online.
PAGE or ARTICLE of an encyclopedia is an entry that covers a specific topic.
COLLABORATIVE (or COLLECTIVE) writing is the process by which multiple users can modify the same page.
WIKI is the method of modifying a page in which a new (modified) copy of the page is created, but the old copy is stored in a memory.
VERSIONS (or REVISIONS) of a page are various copies of the page created by wiki. That is, every modification of a page adds a new version of the page to the list of existing versions.
APPROVED VERSION or ENDORSED VERSION of a page is the version designated as approved by an expert and suitable to be shown to the general public.
CURATOR of a page is a person(s) authorized to approve versions of the page, i.e., to designate them as approved.
EVALUATION of a version is a numerical or symbolic grade assigned to the version (usually by the curator of the page) based on the quality (usefulness) of modification contained in the version.
SCHOLAR INDEX of a user is the measure of usefulness of his/her contribution based on the evaluation of the versions created by the user.

### PREFERRED EMBODIMENT

The preferred embodiment of the invention comprises an electronic encyclopedia stored in a memory, e.g., in a database, allocated in a web server and an engine (a program) that provides the Internet access to the database via the wiki-style collaborative environment. The environment allows multiple users to modify pages (articles) in the encyclopedia by adding new versions of the pages to the list of existing versions. Some versions of pages are designated as approved (i.e., endorsed or certified) by experts.

To display a page to the general public, the engine checks whether an approved version of the page exists. If the page has no approved versions, then the most recent version is displayed (as in all existing wiki-style programs). In addition, a label (a sign) is displayed warning the readers that the page is not approved. If approved versions exist, the most recent approved version is displayed with a label (sign) that the page is approved. (Alternatively, the second recent approved version may be displayed, or a random version from the list of approved versions is displayed.) By default, the readers see approved versions (if they exist). The readers could also view non-approved versions of any page, but this would require additional actions on their part.

The database has a list of registered users, called curators, who have special privileges. A curator of a page is authorized to designate certain versions as approved or endorsed. In the simplest instantiation of the invention, the encyclopedia has a list of approved versions, and curators can add or remove versions from this list. In another, equivalent, embodiment, the encyclopedia has a list of non-approved versions, and curators are authorized to remove versions from the list, thereby making them approved. In another embodiment, curators can assign numeric values to each version, so that versions with high values are approved and with low values are not approved. In yet another embodiment, curators can copy approved versions to a separate location, e.g., a separate database, thereby distinguishing them from non-approved versions. There could be other implementations of the mechanism to designate (or label) some versions as approved to distinguish them from the other versions. As used herein, the term designate refers to these and other mechanisms of marking or distinguishing approved versions from the other versions. The term approve refers to the process of designating a page as approved.

Curators can evaluate versions of pages and assign numerical grades or symbols that reflect the quality of information in the versions. The evaluation is different from the process of approval; that is, an evaluated revision does not have to be approved and the approved revision does not have to be evaluated.

A page can have many curators, and a curator can be assigned (i.e., can curate) multiple pages. Curators can resign from curatorship or they could lose the privilege of curatorship if they do not evaluate new revisions within a reasonable (predefined) period of time.

Each user has an index, called Scholar Index, which is automatically calculated based on the evaluations of versions created by the user. The index measures the quality of users contribution to the encyclopedia judged by the evaluations of curators. When curatorship of a page becomes vacant, it is offered to the user who has the highest index based on the evaluations of versions of the page.

### EXAMPLE OF PREFERRED EMBODIMENT

An example of the preferred embodiment of this invention was created in January of 2006, and it is hosted by Scholarpedia the free peer-reviewed encyclopedia (www.scholarpedia.org). Scholarpedia looks and feels like Wikipedia, since both are powered by the same software MediaWiki and both allow registered visitors to edit articles directly. The MediaWiki consists of a MySQL database storing the encyclopedia pages, their revisions, and other information, and the internet access engine (program) written in the PHP programming language. MediaWiki software powering Scholarpedia was modified to allow for additional features:
1. Each article is reserved and then written by an expert (either invited or elected by the public).
2. Each article is anonymously peer reviewed to ensure accurate and reliable information.
3. Each article has a curator or curators—typically its authors—who are responsible for its content.
4. Any modification of the article needs to be approved by the curators before it appears in the final, approved version.
5. By default, the approved version (if exists) of each article is presented to the public.
6. Non-approved versions can also be accessed, but they are clearly marked as such, with the disclaimer that they may contain incorrect information.

Scholarpedia is a novel form of electronic (web-based) encyclopedia, since the concept of curatorship has never been employed in the context of wiki-style collaborative environment (such as Wikipedia and its earlier peer-reviewed prototypes, GNUPedia and NuPedia). In fact, it is at odds with the wiki-philosophy, since the idea of wiki is that the last revision is the most relevant one, and all previous revisions are kept only for the sake of history. Many have difficulty comprehending the whole idea of separating versions into approved and not approved: Consider a hypothetical page with 10 versions, chronologically arranged as version 1, 2, , 10, with version 7 being approved, so that it is displayed by default. Then, versions 1 through 6 constitute the history of the page, version 7 is treated as if it were the current version of the page, and version 8, 9, and 10, constitute the future of the page pending curators approval. This last feature (i.e, future of an article) has never been implemented in a Wiki-style collaborative environment.

Curatorship

In Scholarpedia, every article has a person who takes care of its content and whose reputation becomes associated with this content, the Curator. The job of a curator is to moderate all submitted revisions of an article, accepting/endorsing those that are relevant and rejecting those that are not. That is, the job of the curator is to designate which versions of the article are approved or certified (or endorsed), and which are not. In some sense, a curator of an article in Scholarpedia is like a curator of a museum: He/she has to evaluate all new additions and decide which are worth public exhibition and which are not. A curators name and affiliation is clearly stated below the title of an article, so that his or her reputation guarantees the accuracy of the article. Each article may have one or more curators, and the same person may curate multiple articles.

Curators of Scholarpedia are leading experts in their respective fields, often having Ph.D. or M.D., and affiliated with an academic, research, or medical organization. A curator may voluntarily resign from curatorship, or may lose the curatorship of an article if he or she does not evaluate new revisions within a reasonable period of time. In this case, the curatorship is offered to the person who has made most contributions to the article (or to the person designated by the current curator). Thus, curatorship of an article can be transferred from one person to another, ensuring that no article is neglected. Each article keeps the history of its curators. In the initial phase of Scholarpedia, the curators were invited by the editor-in-chief. Curators can elect other scientists to become curators of Scholarpedia a practice used by many professional societies, such as the Society for Neuroscience (www.sfn.org).

Scholar Index

Similar to Wikipedia, every registered user can revise and expand articles in Scholarpedia. The revision can be just a simple grammar fix, an attempt to rewrite an obscure paragraph, a suggestion on how to improve the quality of the article, or an in-depth revision of the article with major additions and modifications.

The revisions do not show up until they are approved by the curator of the article. In addition, each revision is evaluated by the curators on the scale from mostly wrong to improvement to major contribution. According to the evaluation, each person receives an index that measures his/her scholarly contribution to the article. When the curatorship of an article becomes vacant, it is automatically offered to the person with the highest index for the article. This mechanism provides the inheritance of the articles in Scholarpedia current curators evaluate revisions of articles made by other people and thereby build future replacement. When time comes, these people take over the articles and become their new curators, evaluating new revisions and building new replacement, and so on.

The sum of all such indices is the persons overall Scholar Index; it measures person's overall scholarly impact on Scholarpedia and it endows the person with certain rights and privileges. For example, Scholar index above certain threshold allow the person to peer-review articles or become a curator of an article without ever contributing to the article (high scholar index means that revisions of that person to other articles were highly valued by the curators).

Peer Review

Each finished article in Scholarpedia is submitted to the anonymous review forum for initial peer review, where reviewers (other experts) can write a short description of what to fix or can directly edit the article and fix it. Scholarpedia provides a simple mechanism to see what changes reviewers made, so authors can see any comma, any space inserted anywhere in the article. Reviewers and authors interact via Scholarpedia, putting notes into the article and sending each other email alerts. Each article forever maintains a history of all of its revisions with all reviewer comments and the author responses. We expect the history of revisions to be of interest in its own right, providing a window into the living process of peer review and progress of ideas that is hidden behind the scenes in traditional publications. Some people may find the dialog between authors and reviewers more interesting that the article itself. Scholarpedia provides a simple mechanism of retrieving appropriate revisions and comparing them.

Upon acceptance, the author of an article becomes its curator. While the names of current curators are placed at the top of the article, signifying their ongoing involvement with and responsibility for the article, the name of the original author of an article will appear at the bottom, and is permanently stored in the Scholarpedia archive. Curatorship can change, whereas authorship cannot.

Generalizations and Extensions

The description of the preferred embodiment above is equally applicable to articles in an Encyclopedia, as well as to a series of articles comprising lecture notes, tutorials, dictionaries, or collection of articles covering a particular subject or subjects.

Although the invention has been described in terms of the illustrative embodiment, it will be appreciated by those skilled in the art that various changes and modifications may be made to the illustrative embodiment without departing from the spirit or scope of the invention. It is intended that the scope of the invention not be limited in any way to the illustrative embodiment described, but that the invention be limited only by the claims appended hereto.

### REFERENCES

Scholarpedia: Free peer-reviewed encyclopedia. (http://www.scholarpedia.org)
Encyclopedia Britannica. (http://www.britannica.com)
Encarta Digital multimedia encyclopedia. Microsoft Inc.
Wikipedia the free encyclopedia that anyone can edit. (http://www.wikipedia.org)
MediaWiki is the name of the wiki-style collaboration environment software and the name of the site (www.mediawiki.org) owned by the WikiMedia Foundation that provides the software source and installation instructions.
Wiki-style environment: see article Wiki in Wikipedia (http://en.wikipedia.org/wiki/Wiki)
PlanetMath virtual community (www.planetmath.org)
PeerPedia (www.peerpedia.com): Peer Reviewed Encyclopedia by Pure Energy Systems (no longer exists)
The Encyclopedia of Earth. Owned by Digital Universe (http://www.eoearth.org/)
Stanford Encyclopedia of Philosophy. (http://plato.stanford.edu)
NuPedia: Free peer reviewed web-based encyclopedia (no longer exists)
GNUPedia: Free content encyclopedia (no longer exists)

What is claimed is:

1. An electronic encyclopedia comprising:
a plurality of pages stored in a memory;
a plurality of versions of said pages stored in the memory;
a wiki-style mechanism of modification of said pages by means of adding new versions of said pages to said memory;
a mechanism to designate said versions as approved or not-approved.

2. The electronic encyclopedia defined in claim 1 further comprising a mechanism to display said versions that are designated as approved.

3. The electronic encyclopedia defined in claim 2, wherein at least one said version designated as approved is displayed with a distinctive label.

4. The electronic encyclopedia defined in claim 2, wherein at least one said version not designated as approved is displayed with a distinctive label.

5. The electronic encyclopedia defined in claim 1 further comprising a mechanism to display said versions of pages with links to versions that are designated as approved.

6. The electronic encyclopedia defined in claim 1 further comprising a mechanism to display said versions of pages with links to versions that are not designated as approved.

7. The electronic encyclopedia defined in claim 1 further comprising a plurality of users, called curators, who can designate said plurality of versions as approved.

8. The electronic encyclopedia defined in claim 1 further comprising a plurality of evaluations of said plurality of versions.

9. The electronic encyclopedia defined in claim 8 further comprising a plurality of users who can modify said plurality of evaluations.

10. The electronic encyclopedia defined in claim 8 further comprising a plurality of users, wherein said plurality of users are assigned indexes based on said plurality of evaluations.

11. The electronic encyclopedia defined in claim 10 and a means of modifying said plurality of users based on said plurality of indexes.

12. The electronic encyclopedia defined in claim 11 wherein said plurality of users can designate said plurality of versions as approved.

13. The electronic encyclopedia defined in claim 7 wherein said plurality of curators can assign plurality of evaluations to said revisions.

14. The electronic encyclopedia defined in claim 13 further comprising a plurality of users, wherein said users are assigned plurality of indexes based on said plurality of evaluations.

15. The electronic encyclopedia defined in claim 14 wherein said plurality of curators can be modified based on said plurality of indexes.
